(19) United States
(12) Patent Application Publication
(10) Pub. No.: US 2007/0103599 A1
(43) Pub. Date: May 10, 2007

(54) Brightness-adjusting device for video wall system and method therefor

(75) Inventor: Cheng Wen-Chin, Jhubei City (TW)

Correspondence Address: Haverstock & Owens, 162 Wolfe Rd., Sunnyvale, CA, 94086, US

(73) Assignee: Lumens Digital Optics Inc.

(21) Appl. No.: 11/542,424

(22) Filed: Oct. 2, 2006

(30) Foreign Application Priority Data
Nov. 8, 2005 (TW) 094139200

(51) Int. Cl. H04N 5/57

(52) U.S. Cl. 348/687

(57) ABSTRACT

A brightness-adjusting device for a screen is provided. The brightness-adjusting device includes a light source providing an incident light required to project an image on the screen, a sensor disposed at a position so as to receive the incident light and obtain a digital brightness signal accordingly, and a processor electrically connected to the sensor, receiving the signal and determining a target brightness for adjusting a brightness of the light source accordingly.

### FIELD OF THE INVENTION

The present invention relates to a brightness-adjusting device for a video wall system and the method therefor, in particular to a brightness-adjusting device for a video wall system and the method therefor by virtue of brightness adjustment of the light source to obtain substantially consistent screen brightness of the video wall system.

### BACKGROUND OF THE INVENTION

Please refer to FIG. 1, which is a schematic diagram showing a conventional brightness-adjusting device for a video wall system. The brightness-adjusting device includes a light source 10, a mirror 11, a digital micro-mirror device (DMD) 12, a brightness correction portion 13, a projection lens 14 and a brightness sensor 15. In the brightness-adjusting device, the light source 10 irradiates light to the mirror 11 and the light is reflected to the DMD 12. When the DMD 12 is in on state, it displays an image to be projected in accordance with an image signal of the brightness correction module 13 and a corrected brightness signal on a screen (not shown) through the projection lens 14. When the DMD is in off state, it reflects the light reflected from the mirror 11 to the brightness sensor 15 and converts the light into a digital brightness signal. The digital brightness signal is further transmitted to the CPU 16 of a master screen (not shown), and meanwhile the digital brightness signals of other slave screen (not shown) are also transmitted to the CPU 16 of the master screen. A brightness correction formula is used to obtain the image signal of a corrected brightness, which is transmitted to the brightness correction module 13 to perform the next image projection.

Such brightness-adjusting device focuses on adjusting the brightness of the image. Since the way of such adjustment is open-loop, the dynamic range of image is easily lost. Besides, because the light source is unable to be adjusted when the image brightness is dimmed, the life of the light source is shortened. Moreover, another prior art adjusts brightness by means of an aperture. However, such prior art is disadvantageous since the lumen out of the light source is high, therefore also shortening the life of the light source.

### SUMMARY OF THE INVENTION

In accordance with a first aspect of the present invention, a brightness-adjusting device for a screen is provided. The brightness-adjusting device includes a light source providing an incident light required to project an image on the screen, a sensor disposed at a position so as to receive the incident light and obtain a digital brightness signal accordingly, and a central processor unit (CPU) electrically connected to the sensor, receiving the signal and determining a target brightness for adjusting a brightness of the light source accordingly.

Preferably, the screen is one of a master screen and a slave screen of a video wall system.

Preferably, the target brightness is a minimum value of a brightness of the light source.

Preferably, the brightness of the light source is adjusted in accordance with the target brightness.

Preferably, the brightness-adjusting device further includes a ballast electrically coupled with the light source and the CPU respectively to adjust the light source in accordance with the target brightness.

Preferably, the sensor further includes an analog/digital converter for obtaining the digital brightness signal.

Preferably, the ballast is coupled with a motor to lower the brightness of the light source projected on the screen by using the motor to move the light source.

Preferably, the brightness-adjusting device further includes a color wheel for performing a color separation processing of the incident light of the light source.

Preferably, the brightness-adjusting device further includes a rod and a condenser for focusing the incident light to a specified direction.

Preferably, the brightness-adjusting device further includes a lens, a digital micro-mirror device and an image card or image board (collectively referred to as image cards), wherein the lens is located at a position for receiving the incident light passing through the condenser and refracting the incident light, the digital micro-mirror device is located at a position receiving an incident light refracted from the lens and is electrically coupled with the image card, and the digital micro-mirror device is controlled by the image card to project the image on the screen.

Preferably, the respective incident light penetrates the respective lens and then is projected on the screen in accordance with an output image signal of the image card and the brightness of the incident light when the respective digital micro-mirror device is activated, and the respective incident light with the brightness is projected to the respective sensor via the respective lens when the respective digital micro-mirror device is inactivated.

In accordance with a second aspect of the present invention, a brightness-adjusting device for a video wall system having a master screen and at least a slave screen is provided. The brightness-adjusting device includes at least two light sources respectively providing a respective incident light required to project a respective image on the respective screen; at least two sensors respectively disposed at a respective position so as to receive the respective incident light and obtain a respective signal; and at least two CPUs, each of which receiving the respective signal, converting the respective signal into a respective brightness signal and determining a target brightness to adjust a respective brightness of the respective light source in accordance with the target brightness.

Preferably, the target brightness is a minimum value of the brightness among the at least two light sources.

Preferably, the brightness-adjusting device further includes at least two ballasts electrically coupled with the respective light sources and the respective CPUs respectively to adjust the respective light sources in accordance with the target brightness.

Preferably, the respective CPU further comprises an analog/digital converter for obtaining the respective brightness signal.

Preferably, the respective ballast is coupled with a respective motor to lower the brightness of the light source by using the motor to move the light source.

Preferably, the brightness-adjusting device further includes at least two color wheels for performing a color separation processing of the respective incident light of the respective light source.

Preferably, the brightness-adjusting device further includes at least two rods and at least two condensers for focusing and projecting the respective incident light to a specific direction.

Preferably, the brightness-adjusting device further includes a lens, a digital micro-mirror device and an image card, wherein the lens is located at a position for receiving the incident light passing through the respective condenser and refracting the incident light, the respective digital micro-mirror device is located at a respective position for receiving an incident light refracted from the lens and is electrically coupled with the respective image card, and the digital micro-mirror device is controlled by the image card to project a respective image on the respective screen.

Preferably, the respective incident light penetrates the respective lens and then is projected on the respective screen in accordance with a respective output image signal of the respective image card and a respective brightness of the respective incident light when the respective digital micro-mirror device is activated, and the respective incident light with the respective brightness is projected to the respective sensor via the respective lens when the respective digital micro-mirror device is inactivated.

Preferably, the CPU of the master screen is connected with the CPU of the at least a slave screen by using one of an RS232 and an RS485 communication means, the brightness signals of the master screen and the at least one slave screen are collected by the CPU of the master screen to determine the target brightness, and the target brightness is transmitted to the CPU of at least a slave screen via the RS232 or RS485 communication means.

In accordance with a third aspect of the present invention, a brightness-adjusting method for a video wall system having a master screen and at least a slave screen is provided. The brightness-adjusting method includes steps of obtaining a first brightness of a first light source of the master screen; obtaining a second brightness of a second light source of the slave screen; determining a target brightness; and adjusting at least one of the first and second brightness of the first and second light sources respectively projected on the master screen and the slave screen.

Preferably, the target brightness is a minimum value of the first and second brightness among the first and second light sources.

The foregoing and other features and advantages of the present invention will be more clearly understood through the following descriptions with reference to the drawing, wherein:

### BRIEF DESCRIPTION OF THE DRAWINGS

FIG. 1 is a schematic view showing a conventional brightness-adjusting device of a video wall system;

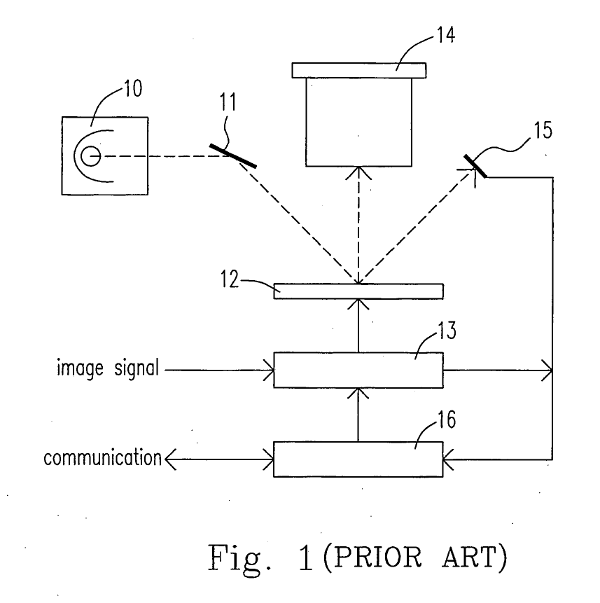

FIG. 2 is a schematic view showing the screen structure of a conventional video wall system;

FIG. 3 is a schematic view showing the brightness-adjusting device of a video wall system according to a preferred embodiment of the present invention;

FIG. 4 is a schematic view showing the closed-loop brightness adjustment for a video wall system according to a preferred embodiment of the present invention; and

FIG. 5 is a flow chart for the brightness adjustment method of a video wall system according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

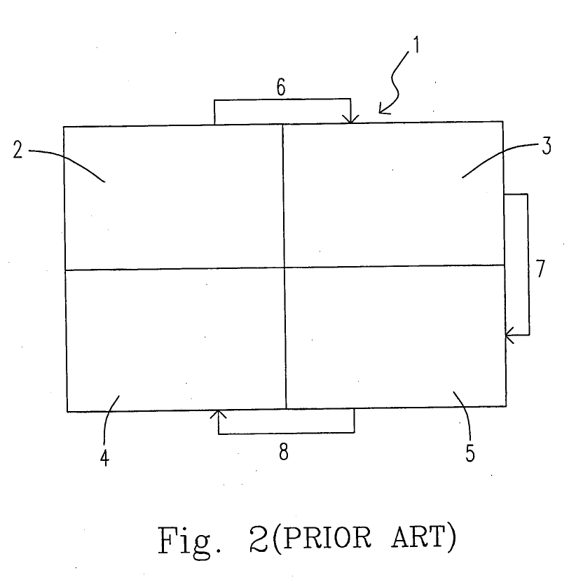

Please refer to FIG. 2, which is a schematic view showing the screen structure of a conventional video wall system. The video wall system includes a master screen 2 and three slave screens 3, 4 and 5, which are interconnected with each other via communication cables 6, 7 and 8 (e.g. RS232 or RS485 cables). The master screen coordinates the data transmitted from all slave screens to display the image. The brightness consistency among the respective screens on the video wall system is important. If the brightness of each screen is inconsistent, the total display effect of the video wall system is certainly inferior.

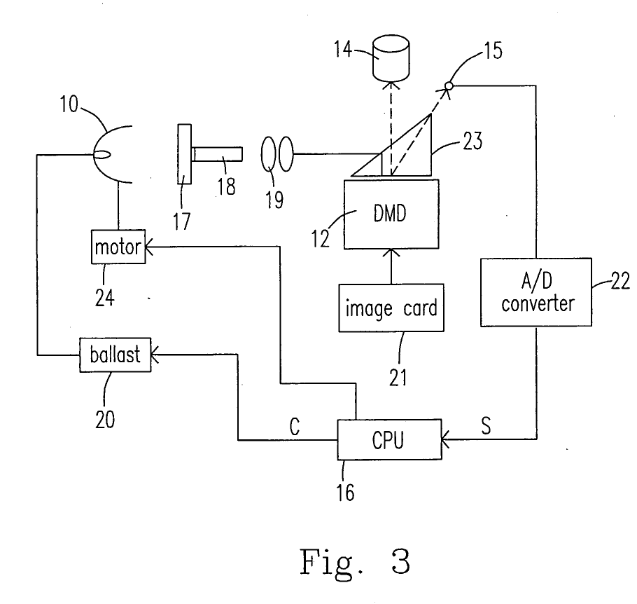

Please refer to FIG. 3, which is a schematic view showing the brightness-adjusting device of a video wall system according to a preferred embodiment of the present invention. The brightness-adjusting device is applicable to each screen of the video wall system and includes a light source 10, a color wheel 17, a rod 18, a condenser 19, a TIR 23, a DMD 12, an image card 21, a sensor 15, a projection lens 14, an analog/digital converter (ADC) 22, a CPU 16, a motor 24 for moving the light source 10 and a ballast 20.

The adjusting mechanism of the video wall system is depicted as follows. The light source 10 irradiates an incident light. The incident light through a color separation processing by the color wheel 17 penetrates through the rod 18 and the condenser 19 to be focused on the TIR 23. Then, the incident light refracted by the TIR 23 enters the DMD 12. When the DMD 12 is powered on, the image data inputted by the image card 21 are directly projected to a screen (not shown) via the projection lens 14 in accordance with the brightness of the incident light. When the DMD 12 is powered off, the incident light is projected to the sensor 15. The sensor 15 receives the incident light and measures its brightness to generate a brightness signal. As the brightness signal is an analog signal, which is unable to be used by the computer device directly, the ADC 22 is used to convert the brightness signal into a digital signal. Meanwhile, because the brightness signal of the incident light contains the brightness of light with the three primary colors (red, green and blue) and of white light (whose brightness is the highest), the ADC 22 plays the role in sampling the white light to obtain the required digital brightness data. However, the sampling in the present invention is not limited to the white light only, but is also available for the light with other colors.

The digital brightness data obtained by the ADC 22 is transmitted to the CPU 16 of the master screen. The CPU 16 of the master screen selects a target brightness of all screens (including the master screen). The target brightness, which is a reference point for brightness adjustment, can be determined by the current brightness of the master screen and the slave screens and is preferable to be the lowest brightness. The target brightness data are simultaneously transmitted to the CPUs of other slave screens as the brightness for the next image display. While the next image is displayed, each CPU of the screens uses the brightness data to set the ballast 20 so that the light sources of all screens irradiate incident light to display with substantially identical brightness. Moreover, if the brightness variation between or among the respective screens is excessively large (e.g. over 20%) and is greater than the range that the ballast can adjust, a motor (not shown) can be used to control the movement of the light source 10. When the light source 10 deviates the position having the highest brightness, the brightness thereof will drop gradually. Using the motor to control the movement of the light source 10 can attain a fast adjustment for brightness consistency in case of large brightness differences among all screens.

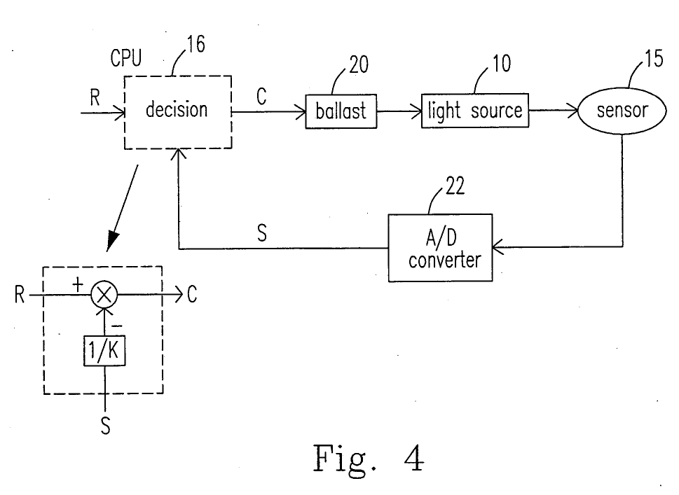

Please refer to FIG. 4, which is a schematic view showing the closed-loop brightness adjustment for a video wall system according to a preferred embodiment of the present invention. The key elements in the closed-loop brightness-adjusting process include a ballast 20, a light source 10, a sensor 15, an ADC 22 and a CPU 16. In addition, as shown in FIG. 4, S represents the digital brightness signal using the ADC to convert the analog brightness signal of the light source 10 sensed by the sensor 15, R represents a target brightness value transmitted by the CPU 16 of the master screen, and C represents a target brightness for the next display obtained in accordance with S and R.

The brightness decision of the light source centered by the CPU 16 is represented by a block with dash lines. The relevant input and output are shown in the lower left side. First of all, as each video wall system is subject to variation resulting from the lighting degree of the light source 10, the sensitivity of the sensor 15 in sensing the brightness and the conversion value of the ADC, the CPU 16 will perform an adjustment during production to generate the system gain value. The formula is expressed as:

$$K = \frac{Δ S}{Δ C}$$

where K is the gain of the system set as a default value with the system, ΔS is the value of the sensed brightness difference between two digital brightness values received by the sensor 15 in sequence and converted by the ADC 22, and ΔC is correspondingly the value of the difference between two target brightness set by the CPU 16 corresponding to the two digital brightness values. The gain is used to calculate the brightness value to be dropped of the light source 10 during the actual display of the video wall system, and can be obtained by targeting the sensed brightness value obtained by the ADC 22. The formula is expressed as:

$$L = \frac{S}{K}$$

where L is the brightness value to be dropped of the light source 10, S is the sensed brightness value obtained by the ADC 22, and K is the gain of the system.

In accordance with the feedback loop calculation, the next brightness value of the light source 10 can be generated. The formula is expressed as:
C=R−L
where R is the current target brightness set by the CPU 16 of the master screen, L is the brightness value to be dropped of the light source 10, and C is the next target brightness set by the CPU 16 of the master screen.

After two to three times of repeated feedback actions, the brightness of the light source 10 can be adjusted within an acceptable error range of the target brightness set by the CPU 16 of the master screen.

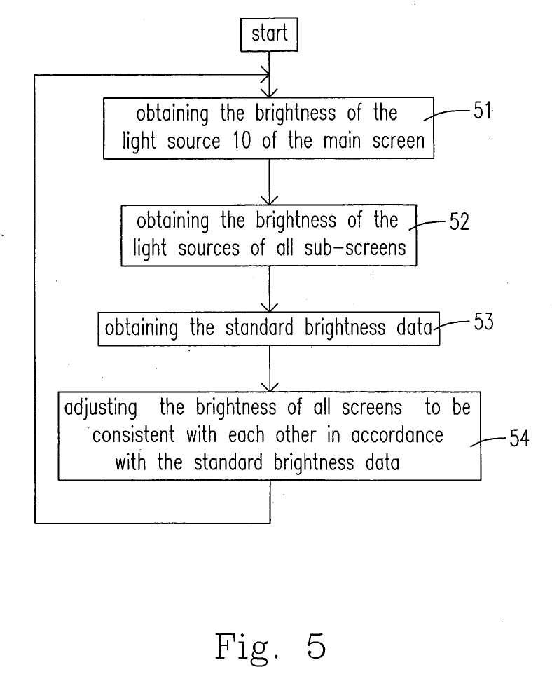

Please refer to FIG. 5, which is a flow chart for the brightness adjustment method of a video wall system according to a preferred embodiment of the present invention. The flow includes the following steps: (a) obtaining the brightness of the light source 10 of the master screen (S51), meaning that the sensor 15 of the master screen senses the brightness of the light source 10 of the master screen and the converted digital brightness data are transmitted to the CPU 16 of the master screen; (b) obtaining the brightness of the light sources of all slave screens (S52), meaning that the sensor of each slave screen senses the brightness of the light source 10 of each slave screen and the converted digital brightness data are transmitted to the CPU 16 of the respective slave screen; (c) obtaining the target brightness data of the master screen and the slave screens (S53), meaning that the CPU 16 of the master screen collects the digital brightness data of all slave screens therein and determines the target brightness data from all the brightness data; (d) adjusting the brightness of all screens to be consistent with each other in accordance with the target brightness data (S54), meaning that the CPU 16 of the master screen returns the target brightness data to the CPU of each slave screen, and the CPU of each slave screen lights up the light source by setting the ballast with the target brightness data and/or moves the position of the light source via the motor.

In sum, the present invention provides a design using the target brightness of the video wall system to directly set the ballast so as to provide the substantially consistent brightness for the light source of each slave screen. In contrast to the prior art, the present invention brings up a closed-loop brightness-adjusting device for the video wall system and the method therefor to improve the drawbacks in the prior art. That is to say, through the present invention, not only the dynamic range of image is improved but also the life of the light source is increased. Accordingly, the present invention can effectively solve the problems and drawbacks in the prior art, and thus it fits the demand of the industry and is industrially valuable.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A brightness-adjusting device for a screen of a video wall system, comprising:
a light source providing an incident light required to project an image on said screen;
a sensor disposed at a position so as to receive said incident light and obtain a digital brightness signal accordingly; and
a processor electrically connected to said sensor, receiving said signal and determining a target brightness for adjusting a brightness of said light source accordingly.

2. The brightness-adjusting device of claim 1, wherein said screen is one of a master screen and a slave screen of a video wall system.

3. The brightness-adjusting device of claim 1, wherein said target brightness is a minimum value of a brightness of said light source.

4. The brightness-adjusting device of claim 1, wherein said brightness of said light source is adjusted in accordance with said target brightness.

5. The brightness-adjusting device of claim 1, further comprising a ballast electrically coupled with said light source and said CPU respectively to adjust said light source in accordance with said target brightness.

6. The brightness-adjusting device of claim 1, wherein said sensor further comprises an analog/digital converter for obtaining said signal.

7. The brightness-adjusting device of claim 5, wherein said ballast is coupled with a motor to lower said brightness of said light source projected on said screen by using said motor to move said light source.

8. The brightness-adjusting device of claim 1 further comprising a color wheel for performing a color separation processing of said incident light of said light source.

9. The brightness-adjusting device of claim 8 further comprising a rod and a condenser for focusing said incident light to a specified direction.

10. The brightness-adjusting device of claim 9 further comprising a lens, a digital micro-mirror device and an image card, wherein said lens is located at a position for receiving said incident light passing through said condenser and refracting said incident light, said digital micro-mirror device is located at a position receiving an incident light refracted from said lens and is electrically coupled with said image card, and said digital micro-mirror device is controlled by said image card to project said image on said screen.

11. The brightness-adjusting device of claim 10, wherein said incident light penetrates said lens and then is projected on said screen in accordance with an output image signal of said image card and said brightness of said incident light when said digital micro-mirror device is in ON state (Mirror is not titled), and said incident light with said brightness is directly projected to said sensor when said digital micro-mirror device is in OFF state (Mirror is titled).

12. A brightness-adjusting device for a video wall system having a master screen and at least a slave screen, comprising:
at least two light sources respectively providing a respective incident light required to project a respective image on the respective screen;
at least two sensors respectively disposed at a respective position so as to receive said respective incident light and obtain a respective signal; and
at least two CPUs receiving said respective signal, converting said respective signals into a respective brightness signal and determining a target brightness to adjust a respective brightness of said respective light sources in accordance with said target brightness.

13. The brightness-adjusting device of claim 12, wherein said target brightness is a minimum value of said brightness among said at least two light sources.

14. The brightness-adjusting device of claim 12, further comprising at least two ballasts electrically coupled with said respective light sources and said CPUs respectively to adjust said respective light sources in accordance with said target brightness.

15. The brightness-adjusting device of claim 12, wherein said respective CPU further comprises an analog/digital converter for obtaining said respective signal.

16. The brightness-adjusting device of claim 14, wherein said respective ballast is coupled with a respective motor to lower said brightness of said respective light source by using said motor.

17. The brightness-adjusting device of claim 12 further comprising at least two color wheels for performing a color separation processing of said respective incident light of said respective light source.

18. The brightness-adjusting device of claim 17 further comprising at least two rods and at least two condensers for focusing and projecting said respective incident light to a specific direction.

19. The brightness-adjusting device of claim 18 further comprising at least two lens, two digital micro-mirror device and two image card, wherein each said lens is located at a position for receiving said respective incident light passing through said respective condenser and refracting said respective incident light, said respective digital micro-mirror device is located at a respective position for receiving an incident light refracted from said lens and is electrically coupled with said respective image card, and said digital micro-mirror device is controlled by said image card to project said image on Respective screen

20. The brightness-adjusting device of claim 19, wherein said respective incident light penetrates said respective lens and then is projected on one of said master screen and said slave screen in accordance with respective output image signal of said image card and a respective brightness of said respective incident light when said respective digital micro-mirror device is in ON state, and said respective incident light with said respective brightness is projected to said respective sensor via said respective lens when said respective digital micro-mirror device is in OFF state.

21. The brightness-adjusting device of claim 12, wherein said CPU of said master screen is connected with said CPU of said at least a slave screen by using one of an RS232 and an RS485 communication means, said brightness signals of said master screen and said at least one slave screen are collected by said CPU of said master screen to determine said target brightness, and said target brightness is transmitted to said CPU of at least a slave screen via said RS232 or RS485 communication means.

22. A brightness-adjusting method for a video wall system having a master screen and at least a slave screen, comprising steps of:
(a) obtaining a first brightness of a first light source of said master screen;
(b) obtaining a second brightness of a second light source of said slave screen;
(c) determining a target brightness; and
(d) adjusting at least one of said first and second brightness of said first and second light sources respectively projected on said master screen and said slave screen.

23. The brightness-adjusting method of claim 21, wherein said target brightness is a minimum value of said first and second brightness among said first and second light sources.
